(19) United States
(12) Patent Application Publication
(10) Pub. No.: US 2026/0189685 A1
(43) Pub. Date: Jul. 2, 2026

(54) PIXEL DEFECT COMPENSATION

(71) Applicant: GOOGLE LLC, Mountain View, CA (US)

(72) Inventors: Alexandra Elizabeth Boehm, San Jose, CA (US); Björn Nicolaas Servatius Vlaskamp, Seattle, WA (US)

(21) Appl. No.: 19/429,643

(22) Filed: Dec. 22, 2025

Related U.S. Application Data
(60) Provisional application No. 63/739,297, filed on Dec. 27, 2024.

(51) Int. Cl. H04N 13/327; H04N 13/344; H04N 13/378; H04N 13/383; H04N 13/398

(52) U.S. Cl. CPC H04N 13/327; H04N 13/344; H04N 13/378; H04N 13/383; H04N 13/398

(57) ABSTRACT

Systems, methods, and apparatuses for temporal compensation for deficient emitters in a display are disclosed. A method may include displaying a first frame where a point within content to be displayed is assigned to a first emitter having a deficiency. Based on motion data indicating a movement of the content between frames, a second emitter is identified that is to display the point for a second frame. Frame data for the second frame is modified to cause the second emitter to at least partially compensate for the deficiency of the first emitter. The display then displays the second frame based on the modified frame data. Other implementations, including a display having a controller configured to perform the method and a non-transitory computer-readable medium storing instructions that cause a device to perform the method, are also described.

### CROSS REFERENCE TO RELATED APPLICATION

This application claims priority to U.S. Provisional Application No. 63/739,297 , filed on Dec. 27, 2024, the disclosure of which is incorporated herein by reference in its entirety.

### BACKGROUND

Digital displays are used in a wide variety of electronic devices, from large-format televisions to the compact screens used in mobile devices and head-mounted extended reality (XR) systems. These displays typically include an array of thousands or millions of individual light-emitting elements, such as pixels or subpixels, that are controlled to collectively generate an image for presentation to a user. Emerging display technologies, such as those that use micro light-emitting diodes (microLEDs), enable high-resolution, high-brightness displays in increasingly small form factors suitable for devices like smartwatches and XR glasses. The manufacturing of these dense arrays of microscopic emitters can be a complex process, and the performance of each individual emitter within the array can impact the overall visual quality and uniformity of the final displayed image.

### SUMMARY

This disclosure describes a technology that makes tiny, broken pixels on advanced screens, like those in augmented reality (AR) glasses, invisible to the human eye. The main problem is that as screen resolutions get higher and pixels get smaller, often a few of them will be defective (e.g., “dead” or “dim”). These show up as distracting dark spots that can ruin the visual experience and lead to expensive manufacturing waste. Implementations of temporal compensation for deficient or defective emitters in a display, such as those described above, are disclosed. The implementations address the technical problem in displays where individual emitters (e.g., microLED subpixels) have deficiencies that can degrade image quality and manufacturing yields. Technical solutions described herein leverage the temporal integration of the human visual system. When a point of content is assigned to a deficient emitter in a first frame, the system identifies a functional, second emitter that is assigned to display that same point in a second frame due to movement of the content relative to the display. The system then modifies the frame data for the second frame to cause the second emitter to compensate for the deficiency of the first emitter, such as by producing more light than would otherwise be called for by the content in the second frame. As a technical effect, the user's visual system averages the light from the first and second frames, thereby making the hardware defect imperceptible in a computationally efficient manner.

In some aspects, the techniques described herein relate to a method including: displaying, on a display having an array of emitters, a first frame including content having a point assigned to be displayed by a first emitter of the array of emitters; identifying, based on motion data indicating a movement of the content from the first frame to a second frame, a second emitter of the array of emitters that is assigned to display the point for the second frame; modifying frame data for the second frame to cause the second emitter to at least partially compensate for a deficiency of the first emitter; and displaying the second frame based on the frame data as modified.

In some aspects, the techniques described herein relate to a display including: an array of emitters; a memory configured to store frame data for a first frame and a second frame; and a display controller communicatively coupled to the memory and the array of emitters, the display controller configured to: display, on the array of emitters, the first frame including content having a point assigned to be displayed by a first emitter of the array of emitters; identify, based on motion data indicating a movement of the content from the first frame to the second frame, a second emitter of the array of emitters that is assigned to display the point for the second frame; modify the frame data for the second frame to cause the second emitter to at least partially compensate for a deficiency of the first emitter; and display the second frame based on the frame data as modified.

In some aspects, the techniques described herein relate to a non-transitory computer-readable medium storing instructions that, when executed by a display controller of a display having an array of emitters, cause the display to perform a method including: displaying, on the array of emitters, a first frame including content having a point assigned to be displayed by a first emitter of the array of emitters; identifying, based on motion data indicating a movement of the content from the first frame to a second frame, a second emitter of the array of emitters that is assigned to display the point for the second frame; modifying frame data for the second frame to cause the second emitter to at least partially compensate for a deficiency of the first emitter; and displaying the second frame based on the frame data as modified.

Various implementations, such as methods, systems, and computer-readable media, are disclosed herein. It will be understood that these various implementations are not mutually exclusive. For example, operations described in the context of a method may be performed by a suitably configured system, and a system may be configured to perform operations described as part of a method. Similarly, instructions stored on a computer-readable medium may cause a system to perform a disclosed method. Further details of these and other implementations are set forth in the accompanying drawings and the description below.

### BRIEF DESCRIPTION OF THE DRAWINGS

FIG. 1 shows an illustrative implementation of temporal emitter deficiency compensation in accordance with principles described herein.

FIGS. 2A and 2B show flowcharts for illustrative methods for performing temporal emitter deficiency compensation in accordance with principles described herein.

FIG. 3 shows a block diagram of an illustrative display configured for temporal emitter deficiency compensation in accordance with principles described herein.

FIG. 4 shows an illustrative environment for implementing temporal emitter deficiency compensation in accordance with principles described herein.

FIG. 5 shows aspects of an illustrative implementation of temporal emitter deficiency compensation based on world-locked content and head movements of a user in accordance with principles described herein.

FIG. 6 shows aspects of an illustrative implementation of temporal emitter deficiency compensation based on animated content presented on a display in accordance with principles described herein.

FIG. 7 shows aspects of an illustrative implementation of temporal emitter deficiency compensation based on eye movement of a user in accordance with principles described herein.

FIGS. 8A and 8B show aspects of illustrative color-based compensation scenarios for temporal emitter deficiency compensation in accordance with principles described herein.

FIG. 9 shows a block diagram of an illustrative computing system for implementing temporal emitter deficiency compensation in accordance with principles described herein.

### DETAILED DESCRIPTION

Implementations described herein are configures to compensate for pixel defects using a solution that tricks the eye. This solution takes advantage of the fact that content on a screen is often moving, especially in augmented reality glasses where world-locked images shift as a user turns their head. When a part of an image that was supposed to be displayed by a broken pixel moves to a working pixel in the very next frame, the system tells that working pixel to shine extra bright for that next frame. The human brain naturally blends these two moments together, averaging out the dim light from the first frame with the extra-bright light from the second. The result is that the user perceives a perfectly lit image, and the original hardware defect becomes completely unnoticeable.

For example, a user may use AR glasses to view a virtual map overlaid on a view of the city. As the user turns their head to look down a street, the map moves across the tiny display inside the glasses. If there were a dead pixel, the user might see a tiny black dot sliding across the map. This technology would use head motion to instantly compensate for that dead pixel by using a neighboring pixel in the next moment, ensuring the map always appears solid and flawless. This not only improves the user experience but also makes it possible to use displays that have minor, otherwise-invisible flaws, which can significantly lower the cost of manufacturing.

To lay out the problem and proposed solutions more specifically, modern digital displays, such as those used in head-mounted extended reality devices, smartwatches, and other devices, may include millions of tiny light-emitting elements called emitters. In an ideal scenario, every one of these emitters functions perfectly to create a clear and uniform image. However, during the complex manufacturing process for these displays, it is not uncommon for a small number of these emitters to be deficient, meaning they may be completely non-functional (“dead”) or unable to reach their intended brightness (“dim”). These individual defects can appear as tiny, distracting dark spots in an image. To address this, technical solutions described herein provide a method for making these defects invisible to the human eye. Instead of attempting to fix the deficient emitter in the same instant (e.g., during the same frame) it is used, this technique operates by using a different, functional emitter in the next instant (e.g., during the next frame) to add a small, precisely calculated boost of light. This second emitter is chosen because it is the one that will be used to show the point of content on the image that the deficient emitter failed to show. This quick substitution works because the human visual system naturally blends and integrates light over very short periods of time. Thus, if the system can present the “missing” light from the defect in the next moment at the correct location relative to the content the user is focused on, the user's brain can be made to perceive both frames with the point in question having the desired brightness, even in spite of the hardware defect. In other words, using computationally-efficient software techniques described herein, certain underlying hardware defects may be made imperceptible, thereby improving manufacturing yields and providing a higher-quality, more uniform visual experience for the user.

The technological context of implementations described herein, as well as various technical problems they address, technical solutions they propose, and technical benefits they provide, will now be described in more detail.

Systems and methods described herein are situated in the general technological field of digital displays, and are particularly applicable to high-resolution displays used in devices where visual quality and manufacturing efficiency are significant considerations. Such devices may include head-mounted extended reality (XR) systems, such as augmented reality (AR) glasses and virtual reality (VR) headsets, as well as other compact devices like smartwatches and mobile phones. The visual foundation of these devices is a display panel, which typically includes a dense array of thousands or millions of individual light-emitting elements, referred to herein as emitters. These emitters, which may be implemented as pixels or subpixels of different primary colors (e.g., red, green, and blue), are individually controlled by a display controller to collectively generate the image content that is to be presented to a viewer of the display (e.g., the user).

A significant trend in modern display technology is the development of emissive displays, such as those based on micro light-emitting diodes (microLEDs). Unlike traditional liquid crystal displays (LCDs) that use a single backlight, each emitter in a microLED display generates its own light. This technology offers numerous advantages, including higher brightness, better contrast, faster response times, and improved power efficiency, making it highly desirable for next-generation devices. Furthermore, the microscopic size of microLEDs enables the creation of extremely high-resolution displays in the very small form factors required by wearable devices such as head-mounted XR devices (e.g., AR glasses, etc.). The pursuit of ever-higher pixel densities and smaller device sizes, however, places immense pressure on the manufacturing processes for these advanced display panels.

A significant technical problem that arises during the manufacturing of these display panels, and particularly for emerging technologies like microLEDs, relates to the presence of point-level defects. Despite significant efforts to perfect manufacturing processes, the mass fabrication and transfer of millions of microscopic emitters onto a backplane may likely result in at least a few individual emitters being deficient. A deficiency may manifest in several ways. For example, an emitter may be completely non-functional (a “dead” emitter), failing to produce any light when activated. In other cases, an emitter may be partially functional but underperforming (a “dim” emitter), meaning that it may be unable to reach the full range of brightness levels required for accurate image reproduction of at least some content. In either case, the result is a localized hardware defect on the display panel.

This technical problem of point-level defects has direct and significant negative consequences for both the end-user experience and the economics of display manufacturing. From a user's perspective, a deficient emitter can appear as a distracting, static dark spot on the screen. In a display that uses colored subpixels, the failure of a single subpixel can lead to a noticeable color error. For example, if a green subpixel in a red-green-blue (RGB) pixel group is dead, that pixel will be unable to correctly produce any color that requires a green component; an intended white color, for instance, would instead appear as magenta. For the manufacturer, this technical problem directly impacts production yields. A display panel with even a few highly noticeable defects may fail quality control and be discarded, which would increase manufacturing costs and material waste. As pixel densities increase, the statistical probability of a panel having at least one defect also increases, making this technical problem an even more critical barrier to the cost-effective production of next-generation displays.

A variety of approaches may be implemented to address the technical problem of pixel defects, each offering unique characteristics suitable for different scenarios. One such approach is spatial compensation, which involves using functional emitters immediately adjacent to a deficient emitter in the same display frame. For example, the brightness of the neighbors of a dim emitter can be slightly increased to help mask the dark spot. This technique provides a direct, intra-frame method for mitigating the appearance of defects and can be particularly effective in certain contexts. Another complementary approach involves pixel-shifting or “wobulation” techniques. In these systems, the entire image is rapidly shifted by a sub-pixel amount between sub-frames, allowing different physical emitters to be used to illuminate the same spatial location in rapid succession. This technique effectively leverages temporal integration over very short durations (e.g., between subframes of a single frame) and without regard to how content or the user's gaze may move between frames.

Each of these approaches may be effective in certain contexts. Temporal compensation techniques described in more detail herein, however, may offer a further, complementary solution that may be particularly well-suited for scenarios involving the movement of content relative to the display, such as with world-locked or animated content in a head-mounted display.

For example, technical solutions described herein may involve performing pixel compensation temporally (rather than functioning purely spatially) and with respect to content motion and/or eye movements of the user (rather than being limited to a particular space corresponding to the deficiency). These technical solutions are based on leveraging two key conditions: the natural temporal integration properties of the human visual system, and the presence of relative motion between the displayed content and the fixed grid of emitters on the display. The human visual system naturally averages, or integrates, light that it receives over a short duration (e.g., up to approximately 0.1 seconds). Technical solutions described herein take advantage of this by spreading the compensation for a deficient emitter across two or more frames (e.g., consecutive or nearby frames in the frame sequence).

Certain aspects of technical solutions described herein may involve a first frame being displayed, and a point on an instance of content that is assigned to be displayed for that frame by a first emitter that is known to have a deficiency. The system may identify a second, functional emitter that is assigned to display that same point on the instance of the content (also referred to herein as a “point of content”) in a second (e.g., subsequent) frame. This identification may be made based on relative motion between the instance of the content and the display's emitter array. For example, if the content is moving relative to the display, a particular point within the content may be displayed using a different emitter in one frame than was used in a prior frame. As such, once the second emitter is identified, the system may modify the frame data for the second frame to cause this second emitter (which may also be referred to as a “surrogate” or “compensating” emitter) to at least partially compensate for the deficiency of the first emitter (e.g., by increasing its brightness as compared to the brightness the second frame would otherwise call for without the modification). When the modified second frame is displayed, the user's eye receives insufficient light from the deficient emitter in the first frame, followed immediately by a surplus of light from the compensating emitter in the second frame. The human visual system integrates these two inputs, resulting in the perception of a single, correctly illuminated point of content.

As has been described, technical solutions disclosed herein may take advantage of relative motion between content (e.g., instances of content such as textual characters, symbols, graphics, etc.) and the emitter array. This relative motion is what leads to different physical emitters being used to render the same point of content over different frames. This condition of content movement may be met in several ways in different contexts. For example, certain scenarios may be particularly relevant for head-mounted display devices. A first example scenario, for instance, involves world-locked content, which refers to virtual objects that are configured to appear stationary in the user's real-world environment. As a user naturally moves their head, the display device must re-render the world-locked object on different physical emitters to maintain its stable appearance relative to the environment. This inherent “rolling” of the content across the emitter array provides the necessary opportunity for temporal compensation. A second example scenario may involve animated content in which a virtual object is programmed to move across the display. In this case, even if the user's head is stationary, the animation of the object itself creates the relative motion.

A variety of advantageous technical effects may arise from technical solutions described herein. For example, one technical effect may be an ability to render hardware defects imperceptible to a user without introducing an undesirable blur or sharpness reduction that can arise with certain spatial compensation techniques. By correcting the defect in the temporal domain, the system may preserve a perfect spatial integrity and sharpness of the image. Another beneficial technical effect may be the direct improvement of manufacturing yields and the corresponding reduction in production costs. By providing an effective, software-based solution to a hardware problem, displays with a small number of deficient emitters that might have otherwise been discarded may now be considered acceptable, increasing the number of viable units from a given manufacturing run.

Advantageously, technical solutions described herein may also be highly computationally efficient. The system can often leverage motion data that is already being generated by the device for other purposes (e.g., based on head-tracking data used to render world-locked content, based on content data incorporating frame-to-frame animation of content, based on eye-tracking data used to provide gaze-based virtual content, etc.). To maximize the accuracy of the compensation, the modification of the second frame may be performed using a “late-stage reprojection” technique. This means the system may wait until the last possible moment before the frame is displayed to use the most up-to-date head-and/or eye-tracking data to identify the correct surrogate emitter, ensuring the compensation is delivered to the correct location relative to the user's gaze.

Technical solutions described herein may be further enhanced with additional optimizations, particularly in devices equipped with an eye-tracking system. In one such optimization, the compensation may be selectively applied only when the deficient emitter is rendering a point of content that falls within the user's foveal region of vision—the small, central area of the retina with the highest visual acuity. Since defects in the periphery are less likely to be noticed, this foveal-contingent approach conserves computational resources by only performing the compensation when and where it is most effective for improving the quality of the experience for the user. In another optimization, the system may use the eye-tracking system to detect saccadic (rapid) eye movements and intelligently deactivate the compensation in response to that movement so as to avoid the potential for creating an undesirable artifact that could occur if a bright, compensating flash were to be applied while the eye is in rapid motion. These and other optimizations described herein may serve to further improve the visual experience.

Certain terminology used in this description may be understood in the following sense to aid in describing principles set forth herein. These definitions are provided as examples and are not intended to be limiting; they may be added to and/or further defined and clarified by the examples described herein.

As used herein, an “array of emitters” may refer to a grid or other arrangement (e.g., a triangular, hexagonal, or other non-rectilinear arrangement) of individual light-generating elements that collectively form a display panel. The array may be planar or curved and may be part of a direct-view display or, in the case of certain head-mounted display devices, may be an imaging source whose light is relayed to a user's eye via one or more optical elements, such as lenses and/or waveguides. An “emitter” may refer to an individual, independently-controllable light-generating component within an array of emitters. For example, an emitter may be implemented as a micro light-emitting diode (microLED) and may function as a subpixel configured to emit a particular primary color of light (e.g., red, green, or blue). A “deficiency” may refer to a condition in which an emitter fails to perform to its intended specification. This may include, for example, a non-functional or “dead” state where the emitter produces no light, or an underperforming or “dim” state where the emitter is unable to produce a level of brightness required for certain content or standards.

As used herein, “content” may refer to a collection of visual information, represented by digital data, that is intended for presentation on a display. In some implementations, content may refer to a particular visual element or set of elements, such as an image, text, or video, that a display system renders for a user to perceive. In some implementations, content is the aggregate of all visual information that a display controller processes to generate an image, which may include one or more discrete graphical objects, textual elements, or a continuous visual field.

In some contexts, an “instance of content” may be referred to as a way of indicating a particular portion, part, or aspect of the overall content (visual information) being displayed (e.g., a certain part of the overall content being displayed). This term is used broadly to refer to a quantum of content for the purposes of tracking its movement between frames and is not intended to be limiting with respect to size, shape, or whether the content forms a discrete or identifiable object. For example, an instance of content may be a graphical object, a character of text, an icon, a symbol, or a graphic, but it may also be a non-discrete portion of a larger image, such as a region of a photograph, a segment of a video frame, a patch of a texture or pattern, or any other visual element or part thereof. A “point” of content may refer to a specific location, feature, or element within an instance of content that serves as the fundamental unit of visual information being tracked by the system for compensation. The point is what is assigned to be displayed by a particular emitter in a given frame and may correspond, for example, to the visual information of a single pixel in a source image or a specific vertex in a vector graphic. For example, if the instance of content is a character of text, a point may be the corner of the character or the tip of a serif; if the instance of content is a graphical object, a point may be a specific feature such as the center of an eye on a character or a vertex in the object's underlying geometric model.

As used herein, “frame data” may refer to a digital data structure that represents the image for one or more image frames. Frame data may contain values that specify the intended state, such as brightness and/or color, for each emitter in an array of emitters for a given frame, and, as will be described, may be the data that can be modified by a display controller to perform compensation. “Motion data” may refer to data that is indicative of a change in position of an instance of content relative to the display's emitter array between a first frame and a second frame. For example, motion data may include data received from or derived based on a head-tracking system, an eye-tracking system, an analysis of changes in frame data between frames, or other such sources. To “at least partially compensate” for a deficiency may refer to a process of modifying an output of a functional emitter to offset the perceptual effect of a deficiency from a different emitter. For example, this may include causing a second emitter to produce a surplus of light, such as an increased brightness, in a second frame to make up for a lack of light from a first, deficient emitter in a preceding first frame. As used herein, a frame may be considered “fully rendered” when it is at a stage in a graphics pipeline where the primary image content has been generated based on scene geometry and textures, immediately prior to final post-processing modifications, such as the compensation techniques described herein, being applied.

As used herein, “world-locked content” may refer to virtual content that is configured to appear stationary with respect to a user's real-world environment. As will be further illustrated and described, this means, as a functional matter, that as the user's head moves, a display device may re-render the world-locked content on different physical emitters to maintain this stable appearance relative to the environment. A “head-mounted display” (HMD) may refer to a wearable display device that is worn on a user's head. The term “extended reality” (XR) may refer to a superset of technologies including augmented reality (AR), virtual reality (VR), and mixed reality (MR), which are often implemented using HMDs.

As used herein, a “foveal region” of a human eye may refer to a small, central area of the retina that is responsible for the highest visual acuity and sharpest vision. A “saccadic movement” may refer to a rapid, voluntary, jerky movement of the eye that abruptly changes the point of fixation. The detection of a saccadic movement may be used by a system as a trigger to deactivate (e.g., temporarily deactivate) a process, such as a compensation process, to prevent potential visual artifacts in the ways described below.

Various implementations will now be described in more detail with reference to the figures. It will be understood that particular implementations described below are provided as non-limiting examples and may be applied in various situations. Additionally, it will be understood that other implementations not explicitly described herein may also fall within the scope of the claims set forth below. Systems and methods for temporal emitter deficiency compensation may result in any or all of the technical effects mentioned above, as well as various additional and/or alternative technical effects and benefits that will be described and/or made apparent below.

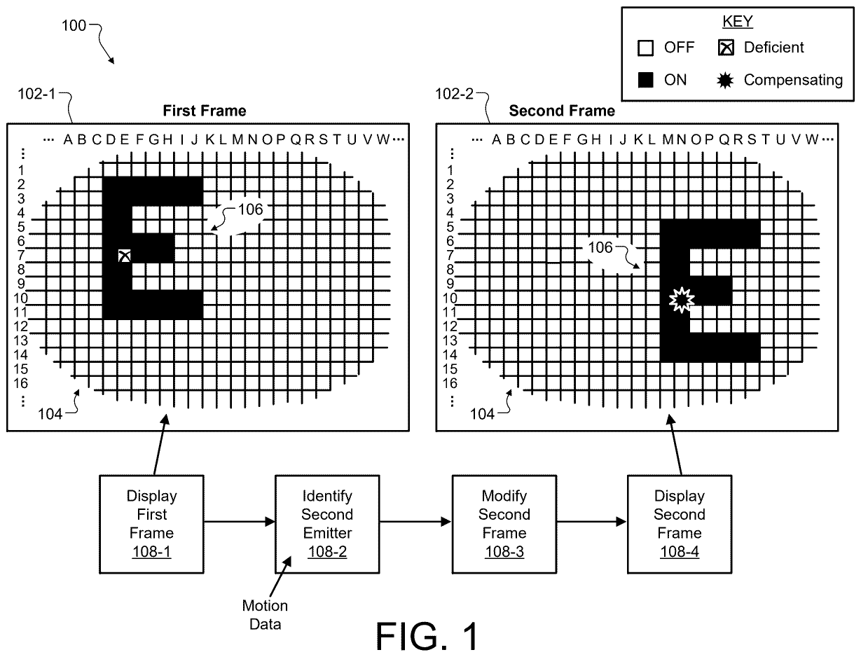

FIG. 1 shows an illustrative implementation 100 for performing temporal compensation for a deficient emitter in accordance with principles described herein. As shown, implementation 100 may include various components and may perform various operations to facilitate the compensation. For example, the figure depicts a first frame 102-1 and a second frame 102-2, which may be displayed on an array of emitters 104, and which, in this example, happen to present an instance of content 106 (e.g., a text character of the letter ‘E’) moving between them. As will be described in more detail below, FIG. 1 illustrates how a deficiency in an emitter used in first frame 102-1 may be compensated for by a different emitter in second frame 102-2 after the instance of content 106 has moved. Also shown is a sequence of corresponding operations 108-1 through 108-4 that may be performed to achieve this compensation.

To aid in understanding the various states of the emitters shown in FIG. 1, a key is provided in a corner of the figure. The key defines four illustrative states that an emitter may be in at a given time within the example. An “OFF” state, represented by a white square, may indicate that an emitter is not emitting light. An “ON” state, represented by a black square, may indicate that an emitter is emitting light at a target brightness level corresponding to the content being displayed. A “Deficient” state, represented by a white square with an ‘X’, may indicate that an emitter has a deficiency and is failing to emit light as intended. A “Compensating” state, represented by a star symbol, may indicate that a functional emitter is emitting additional light to compensate for a deficiency elsewhere. These visual conventions will be used to describe the operation of implementation 100.

As shown, implementation 100 may include an array of emitters 104, which may be understood as the grid of light-emitting elements of a display. While FIG. 1 depicts a relatively small grid for illustrative clarity, it will be understood that array of emitters 104 may contain thousands or millions of individual emitters, as suggested by the ellipses shown along the rows and columns. The figure also includes a grid coordinate system, with columns labeled ‘A’ through ‘W’ and rows labeled ‘1’ through ‘16’, which may be used to reference the specific location of individual emitters within array of emitters 104. In some implementations, each emitter of array of emitters 104 may be implemented as a micro light emitting diode (microLED). Furthermore, each emitter may represent a subpixel configured to emit a particular color of light (e.g., red, green, or blue).

FIG. 1 illustrates the state of the array of emitters 104 at two different moments in time, represented by first frame 102-1 and second frame 102-2. First frame 102-1 depicts the state of array of emitters 104 at a first time. The instance of content 106 (i.e., the letter ‘E’ in this example) is shown being displayed toward the top-left corner of the portion of the emitter array shown. More particularly, the instance of content 106 is shown to be formed by a set of emitters within the array of emitters 104 that are in the “ON” state. As shown, the emitters forming instance of content 106 in first frame 102-1 may be those emitters in a region spanning from approximately emitter D2 (the emitter at column D and row 2) to emitter J11 (the emitter at column J and row 11).

Within first frame 102-1, a specific emitter located at grid position E7 (referred to as emitter E7) is shown to be in the “Deficient” state. This emitter may be referred to as the first emitter. First emitter E7 may be assigned to display a particular point on the instance of content 106 (a point on the ‘E’). As described previously, a deficiency may mean that the emitter is completely non-functional (“dead”) or is underperforming (“dim”), resulting in a lack of brightness at that point in the displayed image.

To address this issue, then, second frame 102-2 depicts the state of array of emitters 104 at a second (e.g., subsequent) time after the first frame has been displayed. As shown by a comparison between the two frames, the instance of content 106 has moved relative to the fixed grid of the array of emitters 104. More particularly, the instance of content (i.e., the ‘E’ in this example) is shown to have moved, for the second frame 102-2, closer to the bottom right corner of the displayed portion of the array. In other words, as shown, the instance of content 106 now occupies a different set of emitters, in the region spanning approximately emitters M5 to S14. This movement of the content may enable certain temporal compensation techniques described herein and may be caused, for example, by the content being world-locked content as a user's head (and a physical display mounted thereon) moves, by the content including an animated object that is programmed to move with respect to the display, or the like.

In second frame 102-2, a different emitter of the array of emitters 104, this one located at grid position N10 (referred to as emitter N10), is shown to be in the “Compensating” state for frame 102-2. This emitter may be referred to as the second emitter. Second emitter N10 may now be assigned to display the same point of the instance of content 106 that was previously assigned to the deficient first emitter E7 in the first frame (i.e., the same point on the ‘E’ object). In this case, the second emitter may be a fully functional emitter that is caused to enter the “Compensating” state to at least partially compensate for the deficiency of the first emitter. In some implementations, this second emitter may also be referred to as a “surrogate” emitter.

FIG. 1 also illustrates a sequence of operations 108-1 through 108-4, which may represent the logical process performed by a component, such as a display controller, to achieve the temporal compensation. The sequence includes a first operation 108-1 (“Display First Frame”), a second operation 108-2 (“Identify Second Emitter”), a third operation 108-3 (“Modify Second Frame”), and a fourth operation 108-4 (“Display Second Frame”).

At operation 108-1, the process begins with displaying the first frame. This corresponds to the visual state shown in first frame 102-1, where the instance of content 106 is displayed using a set of emitters that includes the deficient first emitter at grid position E7. The displaying of this first frame results in an image with a point-level defect, where the user's eye receives insufficient light from the deficient emitter.

At operation 108-2, the process continues with identifying the second emitter. As shown in the figure, this operation may use motion data as an input, as indicated by the arrow labeled “Motion Data.” The motion data indicates the movement of the instance of content 106 from its position in first frame 102-1 to its new position in second frame 102-2. Based on this motion data, the system may identify (e.g., compute, determine, designate, etc.) the second emitter, at grid position N10, as the emitter that is assigned to display the point of interest for second frame 102-2.

Motion data, as used herein, may be derived from a variety of sources. In some implementations, such as for world-locked content, the motion data may be based on data from a head-tracking sensor that measures a user's head movement. In some of these cases, the motion data may be further based on a prediction of a corresponding eye movement based on the vestibulo-ocular reflex (VOR). In other implementations, such as for animated content, the motion data may be based on an analysis of how the frame data for the second frame is different from the frame data for the first frame. In still other implementations, the motion data may be based on eye-tracking data received from an eye-tracking system that directly tracks the user's eye. Each of these examples will be illustrated and described in more detail below.

At operation 108-3, after the second emitter at N10 has been identified, the process includes modifying the frame data for the second frame. This modification is performed to cause the second emitter to at least partially compensate for the deficiency of the first emitter. As shown in the figure, this modification is what causes second emitter N10 to be in the “Compensating” state, where it may be driven to produce a surplus of light to make up for the lack of light produced by first emitter E7 for first frame 102-1.

The modification performed at operation 108-3 may be configured to provide a precise amount of compensation. For example, the modification of the frame data may include modifying a value associated with the second emitter to cause its brightness to increase. The amount of this increase may be based on a degree of the deficiency of the first emitter, such that a larger brightness boost is applied to compensate for a completely dead emitter, while a smaller boost may be applied to compensate for a dim emitter.

At operation 108-4, the process concludes with displaying the second frame based on the frame data as modified at operation 108-3. This corresponds to the visual state shown in second frame 102-2, where the content is displayed with the second emitter at N10 in its “Compensating” state, emitting the additional light needed for the compensation.

While the example shown in FIG. 1 illustrates a scenario where the compensation is performed in a single subsequent frame (i.e., the second frame), it will be understood that in other implementations, the compensation may be distributed across multiple subsequent frames. For example, a single surrogate emitter in the second frame might not have sufficient available brightness capacity, or “headroom,” to deliver the entire compensatory boost all at once. This situation could arise, for example, if the surrogate emitter is already being driven at or near its maximum brightness for the content of the second frame or if the deficient pixel is totally dead and there is a large degree of deficiency of the first emitter. In such cases, the system may be configured to distribute the total required compensation over two, three, four, or more subsequent frames. For instance, if a completely dead emitter was assigned to display a very bright point in the first frame, fully compensating in the next frame might require the surrogate emitter to operate beyond its maximum brightness, which is not possible. To address this, a portion of the compensatory brightness could be added to the second surrogate emitter in the second frame, another portion could be added to another surrogate emitter that displays the point in a third frame, and so on, until the total luminance deficit has been perceptually restored over the temporal integration window of the user's eye.

As a result of this sequence of operations, a beneficial technical effect is achieved. Due to the temporal integration properties of the human visual system, the lack of light from the deficient emitter at E7 in the first frame and the surplus of light from the compensating emitter at N10 in the second frame are perceptually averaged by the user's brain. This results in the user perceiving a single, correctly illuminated point of content, which effectively renders the underlying hardware defect imperceptible. In this way, implementation 100 provides a clear illustration of the foundational principles of temporal compensation techniques described herein.

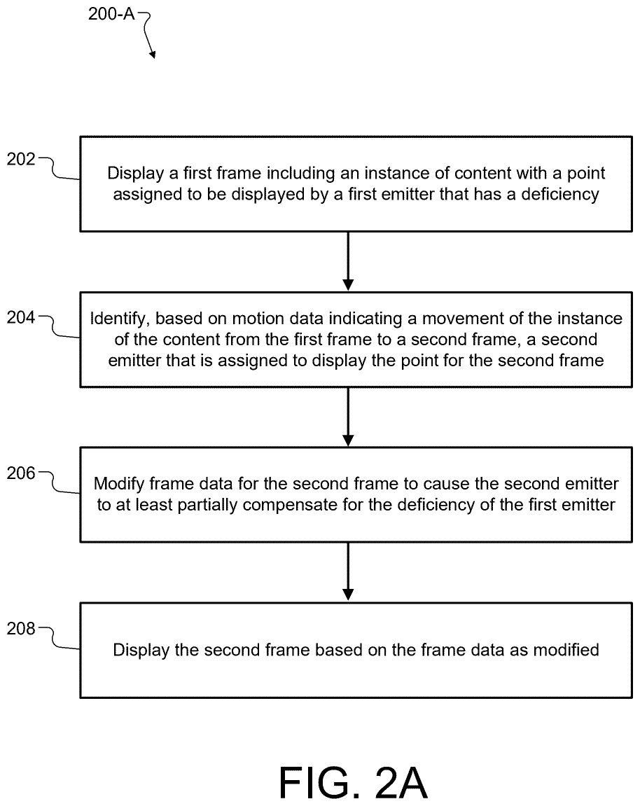

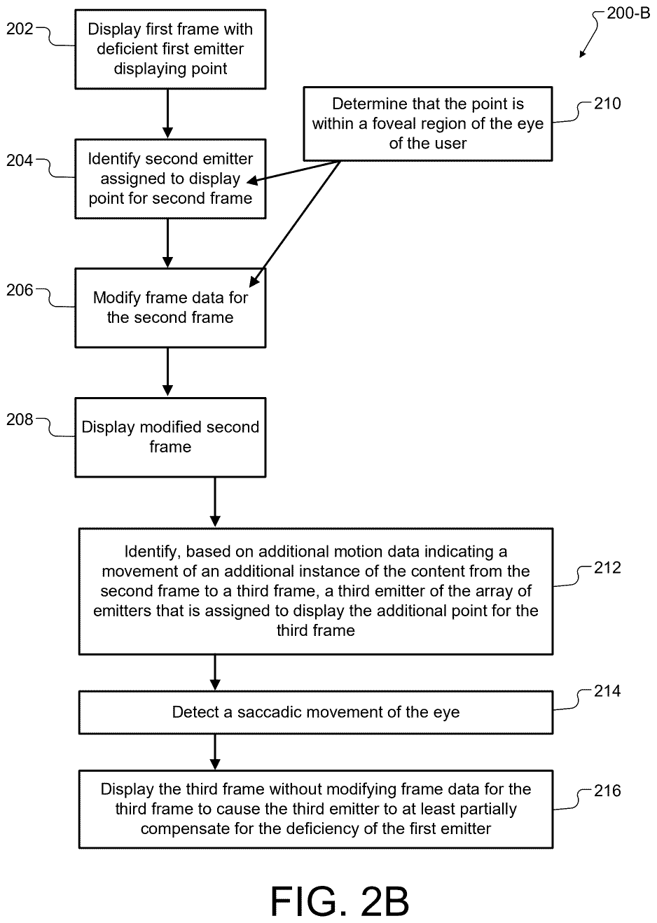

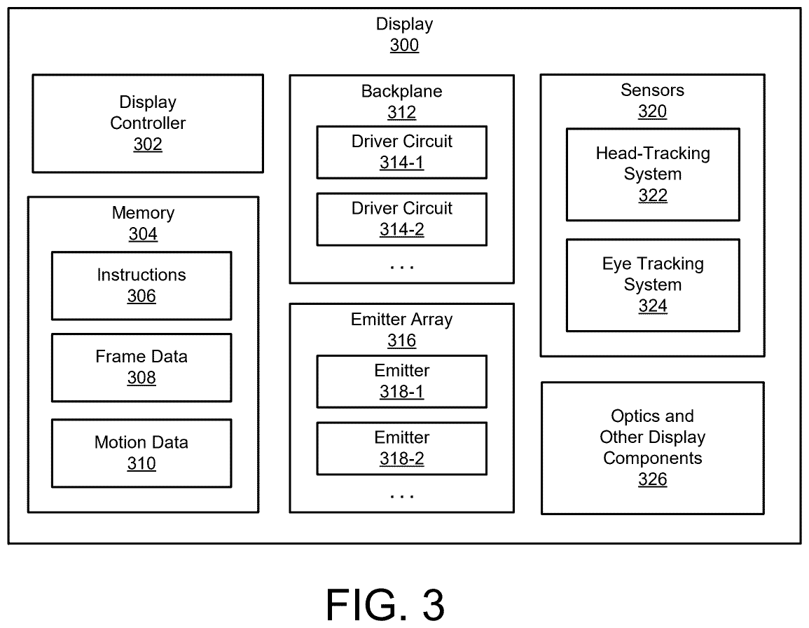

FIGS. 2A and 2B show flowcharts for illustrative methods 200-A and 200-B, respectively, for performing temporal compensation for deficient emitters in accordance with principles described herein. Methods 200-A and 200-B may be performed by various systems, such as implementation 100 of FIG. 1, and/or by devices and components thereof, such as display 300 and its components (described below with reference to FIG. 3). The operations shown in the figures may be performed, for example, by a processor or a display controller executing instructions stored on a non-transitory computer-readable medium. While the operations are shown in a specific sequence for illustrative purposes, it will be understood that other implementations may omit, add to, reorder, and/or modify any of the operations shown as may serve the particular implementation.

Referring first to FIG. 2A, method 200-A is a flowchart that illustrates the core operations of the temporal compensation process. Method 200-A includes a sequence of operations 202, 204, 206, and 208, which together provide a foundational method for implementing technical solutions described herein.

At operation 202, a method may begin with displaying, on a display having an array of emitters, a first frame including an instance of content. The instance of content may include a point assigned to be displayed by a first emitter of the array of emitters. One aspect of this operation is that this particular first emitter has a known deficiency, meaning it is unable to produce the required amount of light for the point of content. This initial display of the first frame thus sets up the technical problem that the subsequent operations will be configured to solve.

In some implementations, a deficiency may also refer to any deviation of an emitter's performance from a predefined operational standard, resulting in a perceivable visual artifact if uncorrected. In some implementations, a deficiency may be any hardware defect in an emitter that causes it to produce an incorrect luminance or chrominance value relative to the value specified by the frame data. In some implementations, a deficiency is a state of an emitter, identified during manufacturing or runtime calibration, that designates it as a target for a compensation algorithm.

At operation 204, the method may proceed to identifying a second emitter of the array of emitters that is assigned to display the same point for a second frame. This identification is the core predictive step of the process, and may be based on motion data that indicates a movement of the instance of the content from the first frame to the second frame. By processing this motion data, the system can determine which functional emitter will take over the task of rendering the specific point of content that was previously rendered by the deficient emitter.

At operation 206, the method may include modifying frame data for the second frame. This modification is the corrective action performed to cause the identified second emitter to at least partially compensate for the deficiency of the first emitter. For example, this may involve a display controller modifying a value associated with the second emitter in the frame data to cause a brightness of that second emitter to increase by a specific amount. This amount may be calibrated and may correspond to a degree of the deficiency of the first emitter (e.g., a larger boost for a dead emitter versus a smaller one for a dim emitter, etc.). In some implementations, this modification may be performed at a late stage in the rendering pipeline, for instance at a stage when the frame data is otherwise fully rendered for display, to ensure the most recent and accurate motion data is used for the compensation.

At operation 208, method 200-A may conclude with displaying the second frame based on the frame data as modified at operation 206. The presentation of this modified frame, with its compensatory boost of light from the second emitter, completes the temporal handoff. The perceptual result of this two-frame sequence is that the user's visual system integrates the light from both frames, making the original point-level defect unnoticeable.

Referring now to FIG. 2B, method 200-B is a flowchart illustrating a more detailed or advanced implementation of temporal compensation. As shown, method 200-B incorporates the core compensation logic of method 200-A but adds further conditional operations based on eye-tracking data to optimize the process and provide additional technical benefits.

Method 200-B may begin by performing a sequence of operations similar to that of method 200-A. For example, as described in operations 202 and 204, a first frame may be displayed where a point of content is assigned to a deficient emitter, and a second emitter may be identified as the surrogate emitter for a second frame based on motion data. Method 200-B then introduces additional, conditional logic to further refine and optimize this process.

At operation 210, after or during the displaying of the first frame as part of operation 202, the method may include an optimization step that involves determining, using an eye-tracking system, that the point assigned to be displayed by the first emitter is within a foveal region of the eye of the user. As described previously, the foveal region is the central, high-acuity part of the retina where a user's visual sensitivity is highest. The subsequent compensation operations, such as identifying the second emitter assigned to display the point for the second frame at operation 204 and modifying the frame data at operation 206, may be performed in response to (i.e., conditional upon) this determination. This foveal-contingent approach provides a significant technical benefit by conserving computational resources and power, as it ensures that the compensation is only performed when the user is most likely to perceive the defect.

If the condition at operation 210 is met (e.g., the system has determined that the user is looking directly at the defect), method 200-B may proceed to operations 204, 206, and 208 to identify the second emitter, perform the compensation, and display the modified second frame, as previously described. In other words, in this path, the frame data for the second frame is modified to include the compensatory brightness boost, and the modified second frame is then presented to the user to complete the compensation event.

Method 200-B may also include an additional logic path for intelligently deactivating compensation to avoid potential visual artifacts. This path illustrates how the system may be configured to handle compensation in the presence of a saccadic eye movement. The process for this path, which may operate in parallel with or as a distinct scenario from the foveal-contingent compensation, may begin at operation 212.

At operation 212, the method may set up a new, distinct compensation scenario to which the deactivation logic can be applied. This scenario begins when, in a subsequent frame (e.g., the second frame or a later frame), an additional point is assigned to be displayed by the original first emitter (the one with the deficiency). This additional point could be part of the original instance of content as it continues to move, or it could be part of an entirely different instance of content that has now moved into a position that requires the use of the deficient emitter. The method then proceeds with identifying, based on additional motion data indicating a movement of the content from that frame to a third frame, a third emitter that is assigned to display this additional point for the third frame. This operation thus establishes a new potential compensation event, setting the stage for the system to decide whether to execute or cancel this new compensation based on the saccade detection that follows.

At operation 214, the method may include detecting, using an eye-tracking system, a saccadic movement of the user's eye. A saccadic movement is a rapid, jerky eye movement which can indicate that the user's gaze is no longer tracking the content. The detection of such a movement can serve as a trigger to temporarily disable the compensation mechanism.

At operation 216, in response to detecting the saccadic movement at operation 214, the method may include displaying the third frame without modifying frame data for the third frame to cause the third emitter to at least partially compensate for the deficiency of the first emitter. By abstaining from this modification, the system advantageously avoids introducing a potential visual artifact, such as a “color breakup” effect, that could arise from applying a bright, compensating flash of light while the user's eye is in rapid motion.

In summary, methods 200-A and 200-B illustrate, respectively, a foundational process and a sophisticated, context-aware process for temporal emitter deficiency compensation. Together, they demonstrate the breadth and flexibility of technical solutions described herein for improving visual quality in displays with deficient emitters.

FIG. 3 shows a block diagram of an illustrative display 300 configured for temporal emitter deficiency compensation in accordance with principles described herein. Display 300 may be an example implementation of the display referred to in implementation 100 of FIG. 1 and may be configured to perform methods such as methods 200-A and 200-B of FIGS. 2A and 2B. As shown, display 300 may include various hardware and software components, such as a display controller 302; a memory 304 storing instructions 306, frame data 308, and motion data 310; a backplane 312 that includes various driver circuits such as driver circuits 314-1 and 314-2; an emitter array 316 that includes corresponding emitters such as emitters 318-1 and 318-2; a set of sensors 320 that includes a head-tracking system 322 and an eye tracking system 324; and optics and other display components 326. These components may be communicatively coupled to interoperate as an integrated system, for example within a head-mounted display (HMD) device, and will each now be described in more detail.

Display controller 302 may be the central processing unit of display 300, configured to orchestrate the operations of the various other components. Display controller 302 may be implemented by one or more processors, such as a central processing unit (CPU), a graphics processing unit (GPU), an application-specific integrated circuit (ASIC), and/or other suitable processing units. A primary role of display controller 302 may be to execute instructions 306 to perform the core compensation logic described herein, including identifying a second emitter based on motion data 310, modifying frame data 308, and controlling backplane 312 to display the resulting images. The configuration of display controller 302 to perform these operations provides a structural basis for the apparatus claims herein.

Memory 304 may be a non-transitory computer-readable medium, such as random-access memory (RAM) or flash memory, that is communicatively coupled to display controller 302. Memory 304 may be configured to store various data and instructions for use by display controller 302. Specifically, as shown, memory 304 may include at least a set of instructions 306, frame data 308 for content to be presented by display 300, and motion data 310 that may be derived or received in any of the ways described herein.

Instructions 306 may represent computer-executable instructions that, when executed by display controller 302, cause display 300 to perform the operations described herein. For example, instructions 306 may cause display 300 to perform methods such as methods 200-A and/or 200-B, as well as to perform other display-oriented tasks.

Frame data 308 may also be stored in memory 304. Frame data 308 may be the digital representation of the images to be displayed, including, for instance, the first frame and the second frame that has been described in examples above. As has been described, frame data 308 may include data that display controller 302 modifies to cause a compensating emitter to change its brightness.

Motion data 310 may also be stored in memory 304. Motion data 310 may be data that is indicative of the movement of an instance of content relative to the display. Motion data 310 may be generated from various sources, as will be further described and illustrated below. In some implementations, motion data 310 may be generated by, received from, and/or derived based on sensors 320 (e.g., head-tracking system 322 and/or eye-tracking system 324). In other implementations, it may be derived by display controller 302 from an analysis of changes in frame data 308 between consecutive frames.

Backplane 312 may be the physical and electrical infrastructure that supports and controls emitter array 316. Backplane 312 may include a substrate, conductive traces, and passive and active components necessary for the operation of emitter array 316. For example, backplane 312 may individual driver circuits (e.g., including current sources or other suitable drivers) corresponding to the individual emitters and configured to cause the emitters to activate and produce light in a manner controlled by display controller 302 (e.g., using a pulse-width modulation (PWM) scheme or other suitable techniques).

Driver circuits, such as a driver circuit 314-1 and a driver circuit 314-2, may be situated on or integrated with backplane 312. Driver circuits 314-1 and 314-2 may be active electronic components configured to receive control signals from display controller 302 and, in response, provide the precise voltage and/or current required to drive individual emitters within emitter array 316 (e.g., including emitter 318-1 and emitter 318-2). The ellipses shown in the figure indicate that a plurality of such driver circuits may be included beyond the two explicitly shown.

Emitter array 316 may implement the grid of individual light-generating emitters that has been described (e.g., analogous to array of emitters 104 described above). As shown, emitter array 316 may include a plurality of emitters such as an emitter 318-1 and an emitter 318-2, that are the source of the displayed image. The ellipses indicate that emitter array 316 may include thousands or millions of such emitters beyond the two shown. In some implementations, each emitter may be implemented as a micro light emitting diode (microLED). Furthermore, each emitter may be implemented as a subpixel configured to emit a particular color of light, such as red, green, or blue.

Sensors 320 may represent the input components of display 300 that are configured to gather real-time data about the user and/or the operating environment. This data may be provided to display controller 302 to be used in the compensation process. As shown, sensors 320 may include sensors associated with, in this example, a head-tracking system 322 and an eye-tracking system 324. In certain implementations, each of head-tracking system 322 and eye-tracking system 324 may include one or more sensors and other sensors 320 not included in the head-tracking system 322 or eye-tracking system 324 may also be included.

Head-tracking system 322 may be a specific implementation of sensors 320. Head-tracking system 322 may include, for example, an Inertial Measurement Unit (IMU) configured to track the orientation and movement of a user's head. An IMU may be a multi-axis sensor package that combines several different types of sensors to provide a comprehensive measurement of an object's motion and orientation. For example, an IMU may include one or more accelerometers, which are configured to measure linear acceleration along different axes (e.g., x, y, and z), and one or more gyroscopes, which are configured to measure angular velocity, or the rate of rotation, around different axes (e.g., pitch, yaw, and roll). By fusing the data from these different sensors, often with the aid of a magnetometer for correcting drift, head-tracking system 322 can provide a highly accurate, real-time estimate of the head's six-degrees-of-freedom (6 DoF) pose. This data may be used as motion data 310 in scenarios involving world-locked content, providing a practical example of a scenario where the motion data is based on a head movement of a user.

Eye tracking system 324 may be another specific implementation of sensors 320. Eye tracking system 324 may include, for example, one or more inward-facing cameras configured to monitor a user's eye. Eye tracking system 324 may serve a dual purpose in some implementations. First, it may provide data that can be used as motion data 310, illustrating a scenario where the motion data is based on eye-tracking data received from an eye-tracking system. Second, it may enable advanced conditional logic described herein, such as determining if a defect is within a user's foveal region and detecting a saccadic movement to prevent artifacts.

Optics and other display components 326 may represent a catch-all category for various other components that may be part of a complete display device but are not explicitly detailed elsewhere in the diagram. For example, this block may include the optical elements, such as lenses, waveguides, combiners, and/or polarizers, that are positioned in the optical path to direct light from emitter array 316 toward a user's eye. These optical components may be essential for forming a viewable virtual image. Beyond the optics, this category may also encompass various mechanical and structural components, such as a main housing or chassis that encloses and protects the internal electronics, as well as any adjustable fitting mechanisms for comfortably securing the device to a user's head. Furthermore, this block may represent other essential circuitry not explicitly shown, such as power management circuitry, battery connections, communication modules (e.g., Wi-Fi or Bluetooth radios), and any associated antennas. In short, this block represents the full suite of additional hardware required to create a functional and manufacturable device, such as a head-mounted display device configured to provide an extended reality experience to a user.

In an example of an overall operation of display 300, sensors 320 (e.g., head-tracking system 322) may generate motion information related to a user's head movement, which is stored in memory 304 as motion data 310. Display controller 302, executing instructions 306, uses motion data 310 to identify a compensating emitter (e.g., emitter 318-2) within emitter array 316 that corresponds to a known deficient emitter (e.g., emitter 318-1). The controller then modifies a value in frame data 308 and, based on the modified data, sends a control signal to the appropriate driver circuit on backplane 312. That driver circuit (e.g., driver circuit 314-2) then drives the corresponding emitter (e.g., emitter 318-2) to produce a compensatory amount of light. The resulting light passes through optics and other display components 326 to be viewed by the user.

Display 300 may be implemented in the context of a head-mounted display device configured to provide an extended reality (XR) experience to a user. In such an implementation, the various components shown in FIG. 3 may be miniaturized and integrated into a compact, wearable form factor, such as a pair of AR glasses or a VR headset. The efficient, software-based compensation methods performed by display 300 are particularly advantageous in such resource-constrained devices, allowing for high visual quality without requiring excessive power or generating excessive heat.

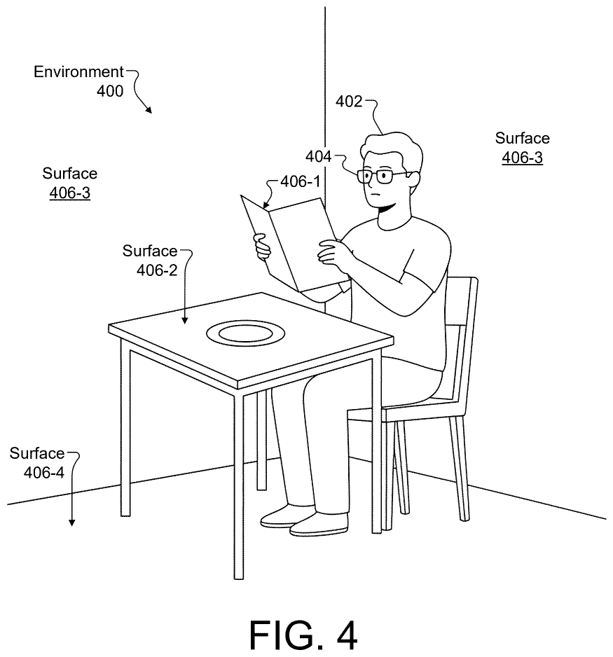

FIG. 4 shows an illustrative environment 400 for implementing temporal emitter deficiency compensation in accordance with principles described herein. This figure provides a practical, real-world context to illustrate how technical solutions described herein may be applied in a dynamic setting. As shown, environment 400 may be a restaurant environment in this example. This environment is shown to include various elements such as a user 402 wearing a display device 404, and various surfaces including a surface 406-1 of a menu, a surface 406-2 of a table, surfaces 406-3 of different walls in the room, and a surface 406-4 of the floor. As shown, each of these surfaces may be at different depths relative to display device 404.

User 402 is shown wearing the display device 404, which may be implemented as a head-mounted display (HMD) device (e.g., a pair of AR glasses in this example). Display device 404 may be configured to present virtual content that is either overlaid on or integrated with the user's view of environment 400. While no specific virtual content is explicitly depicted in FIG. 4, the figure provides a context for describing where such content could be placed and how it would interact with the environment.

The various surfaces shown in the figure, such as the surface of the menu (surface 406-1), the table (surface 406-2), the walls (surfaces 406-3), and the floor (surface 406-4), exist at a range of different distances from user 402. These surfaces represent potential locations in the real world where virtual content could be world-locked or onto which animated content could be projected, creating various possible scenarios where temporal compensation could be applicable.

To provide a first example scenario, FIG. 4 may illustrate the operation of technical solutions described herein with world-locked content. For instance, virtual content may be “world-locked” to appear stationary on one of the surfaces 406-1 to 406-4, such as a virtual notification appearing on the wall at surface 406-3. As user 402 naturally moves their head, this world-locked content will move relative to the display's emitters in order to maintain its fixed position in the world. This relative motion is precisely the condition that enables the temporal compensation, as a point on the virtual content will be rendered by different physical emitters from one frame to the next.

To provide a second example scenario, FIG. 4 may illustrate the operation of technical solutions described herein with animated content. For instance, an instance of content implemented as an animated virtual object, such as a character or icon, could be configured to move across environment 400 (e.g., moving across the table surface 406-2). In this case, even if the head of user 402 is perfectly stationary, the animation of the content itself causes it to move across the display's emitter array. If user 402 tracks this moving object with their eyes, the conditions for temporal compensation may again be met.

To further clarify the scope of technical solutions described herein, these scenarios may be contrasted with head-locked content. If a piece of virtual content, such as a battery status icon, were to be fixed to the user's field of view, it would always be rendered by the same set of emitters, regardless of head movement. In such a static, head-locked case, there would be no relative motion between the content and the emitter array, and therefore no opportunity for the described temporal compensation techniques to be applied.

FIG. 4 thus provides a useful context for understanding certain sources of motion data. For example, the head movements of user 402 relative to the surfaces 406-1 to 406-4 in the world-locked scenario provide one source of motion data, illustrating an implementation where the motion data is based on a head movement of a user. Similarly, the programmed movement of an animated object provides another source of motion data, illustrating an implementation where the motion data may be based on an analysis of how frame data for a second frame is different from frame data for a first frame. This figure bridges the gap between the physical events that occur in a real-world environment and the motion data used by the system, thereby providing strong contextual support for various implementations described herein.

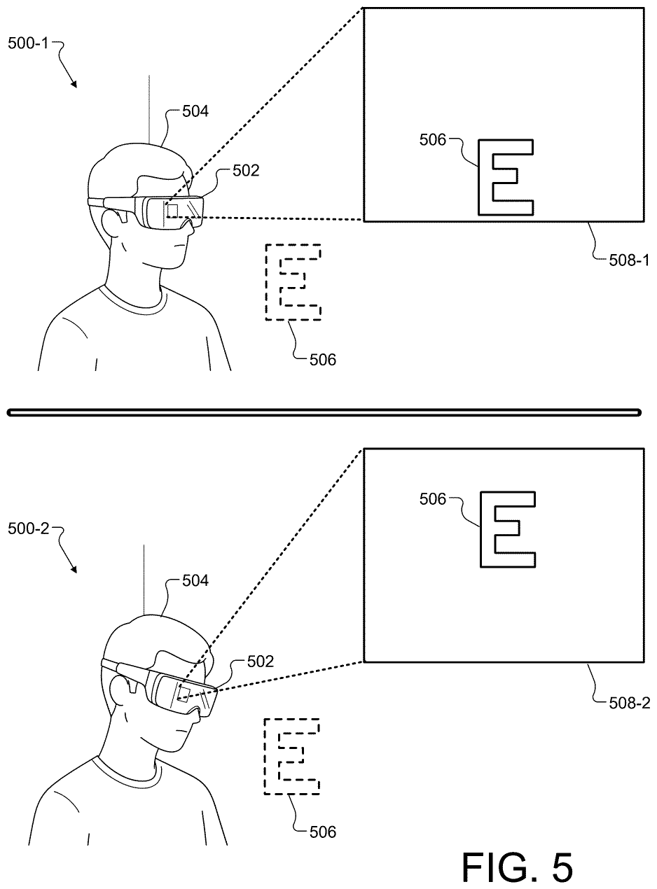

FIG. 5 shows aspects of an illustrative implementation of temporal emitter deficiency compensation based on world-locked content and head movements of a user in accordance with principles described herein. More specifically, FIG. 5 illustrates a system that provides a practical context for the temporal compensation techniques, particularly within a head-mounted display (HMD) application. FIG. 5 represents two instants in time including a first instant 500-1 (above) and a second instant 500-2 (below) to illustrate how a user's head movement may cause virtual content 506 to on the display. As shown, a display device 502 is worn by a user 504 to view virtual content 506 (e.g., a simple letter ‘E’ such as used for the example of FIG. 1 above), which is shown both in its world locked location and as it appears on the display (shown by respective display breakouts 508-1 and 508-2 for instants 500-1 and 500-2, respectively).

As illustrated in FIG. 5, user 504 is shown wearing display device 502, which may be an HMD (e.g., an implementation of display 300) configured to provide an extended reality (XR) experience. Virtual content 506, represented in this example by the letter ‘E’, is shown to be presented to user 504 by display device 502. The figure depicts virtual content 506 in two ways to illustrate the principle of world-locking. The dashed-line version of virtual content 506 represents the content's intended position in the real-world environment, where it remains stationary. The solid-line version of virtual content 506, shown within display breakouts 508-1 and 508-2, then represents the content as it is actually rendered (in different location) on the display of display device 502.

First instant 500-1 illustrates the state of the system at a first time. At this instant, user 504 has their head in a first position, looking forward. As shown in the corresponding display breakout 508-1, virtual content 506 appears in a first position on the display, near the bottom of the user's field of view. In this first frame, a particular point of virtual content 506 may be assigned to a first emitter on the display of display device 502. If this first emitter has a deficiency, the system may be configured to initiate a compensation process that leverages the subsequent movement of the user and content.

Second instant 500-2 illustrates the state of the system at a subsequent, second time. Between the two instants, user 504 has moved their head, specifically by looking downward, as indicated by the change in the orientation of their head. This type of movement is a natural user action that may occur frequently during interaction with an XR experience. A head-tracking system within display device 502 may be configured to detect this change in orientation, providing data that indicates the movement.

The two instants together illustrate the concept of world-locked content and how it generates relative motion on the display. As shown, virtual content 506 is configured to be world-locked, meaning it appears stationary in the user's environment. This is visually represented by the fact that the dashed-line ‘E’ remains in the same fixed position relative to the environment in both instants. Because user 504 has moved their head downward, display device 502 must re-render the content in a different location on its screen (higher up) to maintain this world-locked appearance. This is shown by the solid-line content moving from the bottom of display breakout 508-1 to a position nearer the top of display breakout 508-2. This provides a clear illustration of a scenario where the movement of the instance of the content from the first frame to the second frame is based on the instance of the content being world-locked content.

This physical action of head movement can be directly connected to the motion data used by the system to perform compensation. A display device, such as display device 502, may include a head-tracking system (e.g., head-tracking system 322 of FIG. 3) to detect the downward head movement of user 504. The data generated by this sensor, which indicates the change in head position between the first and second instants, can serve as the motion data used by the system to identify the second emitter for compensation. This provides a practical example of a scenario where the motion data is based on a head movement of a user of the head-mounted display device.

Furthermore, this scenario provides a context for leveraging the human vestibulo-ocular reflex (VOR) in some implementations. As the head of user 504 rotates downward, their eyes may be predicted to rotate upward to maintain fixation on the world-locked virtual content 506. This predictable reflex provides a basis for the system to infer the eye's motion relative to the display, illustrating a scenario where the motion data is based on a prediction that an eye movement of the user has a velocity substantially equal and opposite to the rotational velocity of the head movement.

In summary, FIG. 5 illustrates a key enabling scenario for the compensation technology. The natural head movements of a user viewing world-locked content in an HMD create the necessary relative motion between the content and the display's emitters. This allows the system to assign the same point of content to a deficient emitter in one frame and a functional, compensating emitter in a subsequent frame, thereby making the temporal compensation process possible in a common and practical use case.

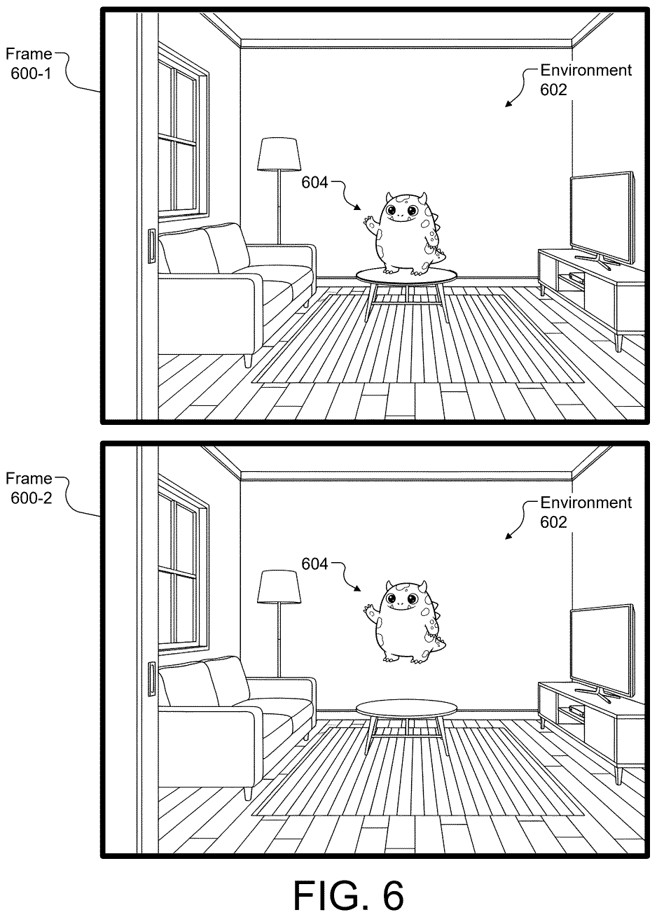

FIG. 6 shows aspects of an illustrative implementation of temporal emitter deficiency compensation based on animated content presented on a display in accordance with principles described herein. This figure illustrates another scenario where temporal deficiency compensation may be applied, in this case for animated content. As shown, the figure depicts an environment 602 in which virtual content 604 is displayed, with a first frame 600-1 showing the content at a first time and a second frame 600-2 showing the content at a subsequent time after it has moved.

Environment 602 may be a static scene, such as a room within a user's home, that a user may be viewing through an augmented reality (AR) display device. The room may contain various real-world objects and furniture, such as a sofa, a television, a coffee table, a lamp, a rug, and a window. The instance of virtual content 604 is shown to represent an animated object (e.g., a whimsical monster character in this example), which may be programmed to appear as if it is interacting with the real-world environment. For example, the monster character may be rendered to appear as if it is positioned on the coffee table, and it may be programmed with various animations, such as waving at the user and/or jumping up and down on the table.

First frame 600-1 shows virtual content 604 at a first position within environment 602 at a first moment in time. In this frame, the animated monster character is depicted as standing on the surface of the coffee table and waving. If a deficient emitter happens to be used to display a point of the content in this frame (for instance, a point on the monster's arm as it waves), an opportunity for temporal compensation may be available in the next frame as the character continues its animation.

Second frame 600-2, which occurs at a subsequent moment in time (e.g., the subsequent frame, in one example, though the amount of movement of the content from frame 600-1 to frame 600-2 may be exaggerated for illustrative effect), shows that the instance of virtual content 604 may move to a new position relative to the static environment 602. In this example, the animation of the character has caused it to jump approximately one foot into the air above the coffee table. Due to this movement (i.e., the jump), any given point of content that may have previously been rendered by a deficient emitter in the first frame would now be rendered at a different location on the display's emitter array for the second frame.

The movement of virtual content 604 shown between the two frames illustrates a scenario where the movement of the instance of the content from the first frame to the second frame is based on an animation of the content. This animation creates relative motion between the content and the display's emitter array, even if the user's head were perfectly stationary (which is noted to be relatively rare anyway, as users typically are in constant motion from small shifts due to breathing, etc.), thereby providing the conditions described for temporal compensation techniques described herein.

This visual example may also be connected to the motion data used to perform compensation. For example, a display controller could generate the required motion data by performing an analysis of how the frame data for the second frame is different from frame data for the first frame to determine the change in position of virtual content 604. This figure hence may provide a clear example of a scenario where the motion data is based on an analysis of frame data differences.

In summary, FIG. 6 illustrates the animated content scenario, which is a second primary use case (alongside the world-locked content scenario) that enables temporal compensation implementations described herein. The programmed movement of the animated object itself provides the opportunity to use a different, functional emitter in a subsequent frame to compensate for a deficient emitter used in a prior frame, assuming the user's gaze is following the object.

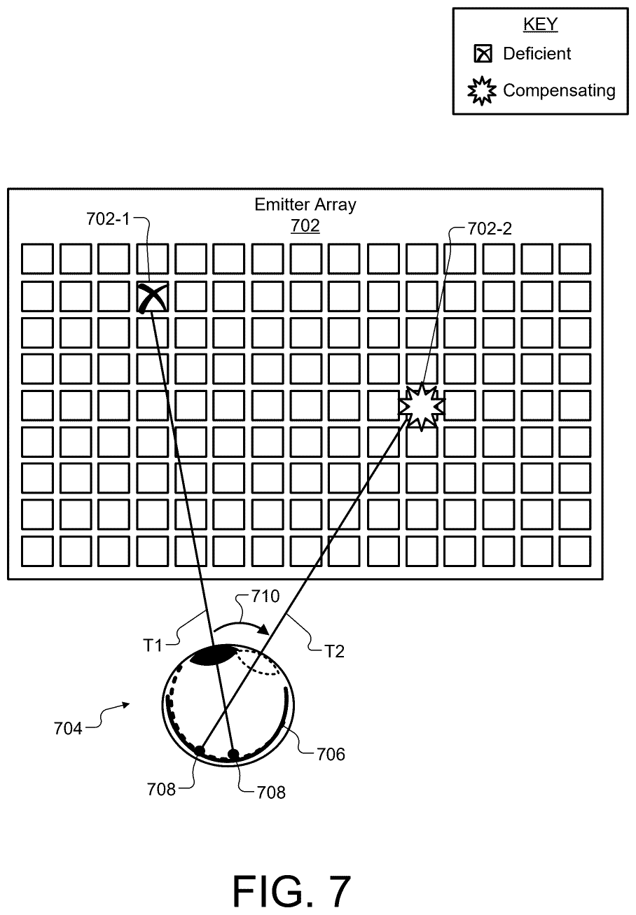

FIG. 7 shows aspects of an illustrative implementation of temporal emitter deficiency compensation based on eye movement of a user in accordance with principles described herein. This figure provides a conceptual diagram illustrating the temporal compensation process from a physiological perspective, showing how the system may leverage direct tracking of a user's eye to perform compensation. As will be described, the figure illustrates how a movement of a user's eye may cause a single retinal point to correspond to different emitters of an emitter array 702 at two different moments in time (labeled T1 and T2).

The implementation shown includes a portion of an emitter array 702, which may be part of a larger display grid. As indicated by a key in the figure, emitters within the array may be in different states. A “Deficient” state, represented by a square with an ‘X’, indicates an emitter with a known defect. A “Compensating” state, represented by a square with a star symbol, indicates a functional emitter that has been modified to provide compensatory light. The figure highlights two specific emitters of interest: a first emitter 702-1, shown as deficient, and a second emitter 702-2, shown as compensating.

Also shown is a user's eye 704, which is positioned to view content presented by emitter array 702. The diagram illustrates several key components of eye 704 to provide physiological context. Light from the emitters enters the eye through an unlabeled pupil and is focused by an unlabeled lens onto retina 706, which is the light-sensitive surface lining the back of the eye. A specific retinal point 708 is highlighted on retina 706. This retinal point 708 may represent a small group of photoreceptors (e.g., cones and rods) that are stimulated by light from the display. In many scenarios, and particularly when compensation is particularly desirable, retinal point 708 may be located within the user's fovea, which is a central area of retina 706 responsible for the sharpest, highest-acuity vision.

At a first time, T1, the system is in a first state, which is represented by the components drawn with solid lines. At this time, a point of an instance of content is assigned to be displayed by first emitter 702-1. A ray of light is shown traveling from first emitter 702-1 and being focused by the lens of eye 704 onto retinal point 708. This illustrates a scenario in which a user is looking directly at a point of content that is being rendered by a deficient emitter, resulting in insufficient light stimulating retinal point 708.

At a subsequent, second time, T2, the system is in a second state, represented by the components drawn with dotted lines. Between times T1 and T2, eye 704 has undergone a movement 710, such as a rotation to track a moving object. This movement causes retina 706 to be in a new position. Due to this movement, the same retinal point 708, which has moved along with the rest of the eye, now aligns with a different emitter on the fixed emitter array 702. As shown at time T2, retinal point 708 is now aligned with second emitter 702-2. A ray of light is shown traveling from second emitter 702-2 and being focused onto the same retinal point 708. This illustrates the temporal handoff, where the same retinal point is stimulated by two different physical emitters at two different times.

This physiological process provides a clear basis for a method of determining the movement of content based on direct eye tracking. For example, a display device may include an eye-tracking system, such as eye tracking system 324 of FIG. 3, which may be configured to detect movement 710 of eye 704. The data generated by the eye-tracking system, indicating this movement, can be used by a display controller as the motion data for performing compensation. This motion data allows the system to identify second emitter 702-2 as the correct surrogate emitter to compensate for the deficiency of first emitter 702-1, thereby providing a clear illustration of a scenario where the motion data is based on eye-tracking data received from an eye-tracking system.

Furthermore, this figure provides a context for certain optimizations that may be performed by an eye-tracking-enabled system. For example, the compensation may be most effective and necessary when retinal point 708 is within the user's fovea, where visual sensitivity to defects is highest. Accordingly, an eye-tracking system may first be used to determine that the point assigned to be displayed by the first emitter is within a foveal region of the eye of the user. The subsequent steps of identifying the second emitter and modifying the frame data for the second frame may then be performed in response to this determination. This foveal-contingent approach allows the system to conserve computational resources by only performing the compensation when it is most likely to be perceived by and beneficial to the user.

In summary, FIG. 7 provides a physiological basis for an eye-tracking-based compensation method. The figure illustrates how natural movements of a user's eye can cause different physical emitters to stimulate the same retinal point over time. By showing this, the figure demonstrates how an eye-tracking system can measure this movement to enable the compensation process, providing a clear illustration of a primary method for determining the movement of content relative to the display.

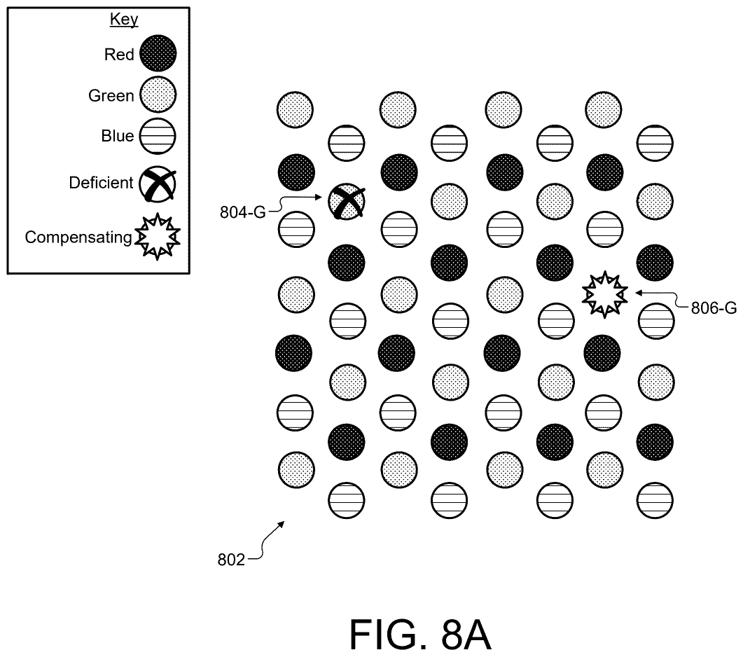

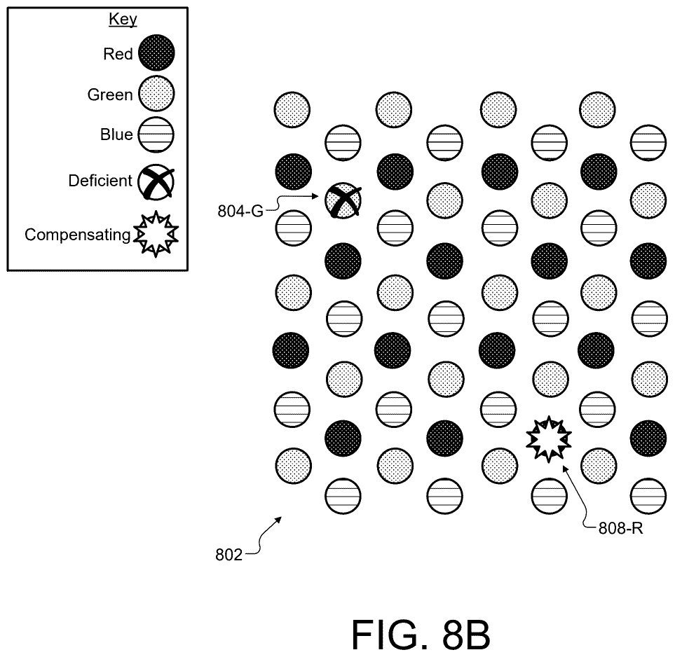

FIGS. 8A and 8B show aspects of illustrative color-based compensation scenarios for temporal emitter deficiency compensation in accordance with principles described herein. These figures illustrate compensation scenarios within a multi-color emitter array 802, showing how a system may compensate for a deficient emitter of one color by using either a surrogate emitter of the same color (as in FIG. 8A) or a different color (as in FIG. 8B), depending on the implementation and display characteristics.

As shown, FIGS. 8A and 8B both depict a portion of a multi-color emitter array 802. A key provided in the figures defines the visual conventions used. Specifically, the key indicates that the array includes emitters configured to emit red light (R), green light (G), and blue light (B). The key also defines the symbols for a “Deficient” state (an ‘X’) and a “Compensating” state (a star symbol). The emitters in emitter array 802 are shown arranged in a hexagonal, or offset lattice pattern, which represents one possible layout for the subpixels in a modern display. This pattern may also be referred to as a triangular lattice pattern as each pixel (i.e., each group of one red subpixel, one green subpixel, and one blue subpixel) is arranged as an equilateral triangle on the hexagonal grid.

While emitter array 802 depicts a specific hexagonal layout, it will be understood that the principles of color-based compensation described herein are applicable to various other subpixel arrangements. For example, some displays may utilize a rectilinear RGB stripe pattern, where red, green, and blue subpixels are arranged in repeating vertical columns. Other displays may use more complex layouts such as those that use different numbers or arrangements of the primary color subpixels. The compensation techniques may be adapted to function with any suitable regular or irregular lattice type used in a display.

In both FIG. 8A and FIG. 8B, the compensation process begins with a common scenario involving a first emitter 804-G. As shown, first emitter 804-G is a green subpixel that is in a deficient state. In a first frame, a point of an instance of content may be assigned to be displayed by this deficient emitter, which would result in a lack of green light at that location in the image.

Referring now specifically to FIG. 8A, this figure illustrates a same-color compensation scenario. In this implementation, after the instance of content has moved (e.g., between a first frame and a second frame), the point of content is now assigned to be displayed by a second emitter 806-G. As shown in the figure, second emitter 806-G is also a green subpixel, which has been placed in a compensating state. This figure thus provides a clear illustration of an implementation where the first emitter and the second emitter both implement subpixels of the display that are configured to emit a same color of light.

Referring now specifically to FIG. 8B, this figure illustrates a different-color compensation scenario. In this alternative implementation, after the instance of content has moved, the point of content is instead assigned to be displayed by a second emitter 808-R. As shown, second emitter 808-R is a red subpixel, which is a different color from the deficient green emitter. This figure thus provides a clear illustration of an implementation where the first emitter implements a first subpixel configured to emit a first color of light (green, in this example), and the second emitter implements a second subpixel configured to emit a second color of light (red, in this example), the second color of light being different from the first color of light.

The choice between same-color and different-color compensation may depend on various factors, such as the characteristics of the display. For example, the effectiveness of different-color compensation may be related to the display's resolution or pixel density. At very high resolutions, the human visual system's spatial frequency response for color (chrominance) is lower than its response for brightness (luminance). This means that at a fine scale, the eye is more sensitive to variations in brightness than it is to variations in color. In such high-density displays, using a nearby emitter of a different color, as illustrated in FIG. 8B, can be a perceptually acceptable way to restore the missing luminance, as the primary goal is to “fill in” the dark spot created by the deficient emitter. Furthermore, this different-color approach may also be desirable as a fallback option in situations where a suitable same-color surrogate emitter lacks sufficient brightness headroom to provide the necessary compensation (as further described below).

In other contexts, such as on displays with a lower pixel density, same-color compensation may be preferred. At lower resolutions, the physical separation between different-colored subpixels is more apparent to the human eye, and using the wrong color for compensation could introduce noticeable visual artifacts, such as color fringing. In these cases, the same-color compensation approach illustrated in FIG. 8A may provide a better perceptual result. In some same-color implementations, the system may also consider the available brightness “headroom” of potential surrogate emitters. For example, if the nearest same-color emitter is already being driven at or near its maximum brightness for the second frame, the system may be configured to select the next-nearest same-color emitter that has sufficient available capacity to provide the required compensatory brightness boost.

In summary, FIGS. 8A and 8B demonstrate the flexibility of the compensation algorithm. By illustrating both same-color and different-color compensation implementations, the figures show how a system may adapt its compensation strategy based on factors such as display resolution, emitter layout, and available emitter headroom, to achieve the most effective perceptual compensation for a deficient subpixel.

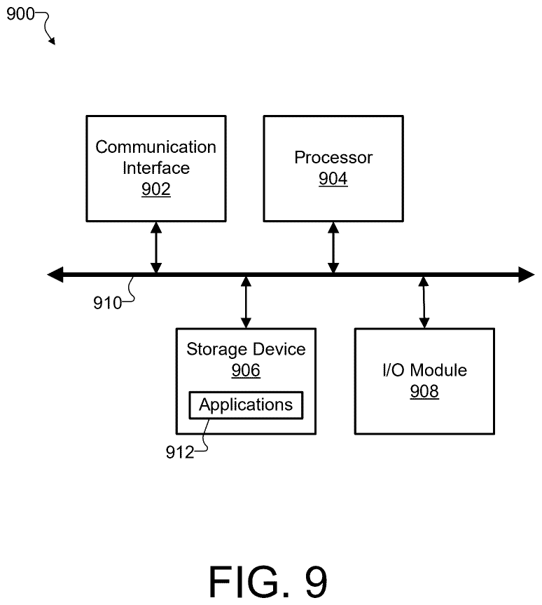

FIG. 9 shows a block diagram of an illustrative computing system 900 for implementing temporal emitter deficiency compensation in accordance with principles described herein. Computing system 900 may be used to implement various devices and/or systems described herein. For example, computing system 900 may be used to implement the hardware of display 300, its display controller 302, or other devices configured to perform the temporal compensation methods. The components shown are illustrative and not intended to be limiting, as additional or alternative components may be used in other implementations.

As shown, computing system 900 may include a communication interface 902, a processor 904, a storage device 906, and an input/output (I/O) module 908 communicatively connected via a communication infrastructure, such as a bus 910. These components may interoperate to perform the various functions of the system.

Communication interface 902 may be configured to communicate with one or more other computing devices or networks. Examples of communication interface 902 include, without limitation, a wired network interface (such as a network interface card), a wireless network interface (such as a Wi-Fi or cellular interface card), a modem, and any other suitable interface for data exchange.

Processor 904 generally represents any type or form of processing unit capable of processing data or interpreting and executing instructions. For example, processor 904 may be an implementation of display controller 302. Processor 904 may direct execution of operations in accordance with one or more applications 912 or other computer-executable instructions such as may be stored in storage device 906 or another computer-readable medium.

Storage device 906 may include one or more data storage media, devices, or configurations and may employ any type, form, and combination of data storage media and/or device. For example, storage device 906 may include, but is not limited to, a hard drive, solid-state drive, flash memory, random-access memory (RAM), or a combination thereof. Storage device 906 may be an implementation of a non-transitory computer-readable medium and is shown to store one or more applications 912. Applications 912 may represent computer-executable instructions that, when executed by processor 904, cause computing system 900 to perform the disclosed methods.

I/O module 908 may include one or more modules configured to receive user input and provide user output. For example, I/O module 908 may include hardware and/or software for capturing user input, including, but not limited to, a keyboard, a touchscreen component, or one or more sensors. I/O module 908 may also include one or more devices for presenting output to a user, including a graphics engine and one or more output drivers for a display. In the context of the systems described herein, I/O module 908 may manage output to an emitter array, such as emitter array 316, and may receive input from various sensors, such as sensors 320.

Bus 910 may be implemented as a communication infrastructure that facilitates data and control signal exchange between the various components of computing system 900.

In summary, computing system 900 provides an example of a hardware environment for implementing the described methods and systems. The various components interoperate to perform the functions of the system, for instance with processor 904 executing applications 912 from storage device 906 to control the other components via bus 910.

The following clauses describe implementations of temporal pixel defect compensation in accordance with principles described herein.

Clause 1. A method comprising: displaying, on a display having an array of emitters, a first frame including an instance of content, the instance of content including a point assigned to be displayed by a first emitter of the array of emitters, the first emitter having a deficiency; identifying, based on motion data indicating a movement of the instance of the content from the first frame to a second frame, a second emitter of the array of emitters that is assigned to display the point for the second frame; modifying frame data for the second frame to cause the second emitter to at least partially compensate for the deficiency of the first emitter; and displaying the second frame based on the frame data as modified.

Clause 2. The method of clause 1, wherein: the display is integrated within a head-mounted display device; and the motion data is based on a head movement of a user of the head-mounted display device.

Clause 3. The method of clause 2, wherein: the head movement has a rotational velocity; and the motion data is based on a prediction that an eye movement of the user has a velocity equal and opposite to the rotational velocity of the head movement.

Clause 4. The method of clause 1, wherein the motion data is based on an analysis of how the frame data for the second frame is different from frame data for the first frame.

Clause 5. The method of clause 1, wherein: the display includes an eye-tracking system configured to track an eye of a user of the display; and the motion data is based on eye-tracking data received from the eye-tracking system.

Clause 6. The method of clause 1, further comprising determining, using an eye-tracking system configured to track an eye of a user of the display, that the point assigned to be displayed by the first emitter is within a foveal region of the eye of the user; wherein the identifying of the second emitter and the modifying of the frame data for the second frame are performed in response to the determining that the point is within the foveal region.

Clause 7. The method of clause 1, wherein: the second frame includes an additional instance of the content that includes an additional point assigned to be displayed by the first emitter having the deficiency; and the method further comprises: identifying, based on additional motion data indicating a movement of the additional instance of the content from the second frame to a third frame, a third emitter of the array of emitters that is assigned to display the additional point for the third frame; detecting, using an eye-tracking system configured to track an eye of a user of the display, a saccadic movement of the eye; and based on the saccadic movement of the eye, displaying the third frame without modifying frame data for the third frame to cause the third emitter to at least partially compensate for the deficiency of the first emitter.

Clause 8. The method of clause 1, wherein the modifying of the frame data for the second frame includes modifying a value associated with the second emitter to cause a brightness of the second emitter to increase, for the second frame, by an amount corresponding to a degree of the deficiency of the first emitter.

Clause 9. The method of clause 1, wherein the modifying of the frame data for the second frame is performed at a stage when the frame data is fully rendered for display based on the instance of the content.

Clause 10. The method of clause 1, wherein: the display is integrated within a head-mounted display device worn by a user within an environment; and the movement of the instance of the content from the first frame to the second frame is based on the instance of the content being world-locked content configured to appear stationary with respect to the environment as the user moves to change a field of view of the head-mounted display device.

Clause 11. The method of clause 1, wherein: the instance of the content is an animated object; and the movement of the instance of the content from the first frame to the second frame is based on an animation of the animated object.

Clause 12. The method of clause 1, wherein the first emitter and the second emitter both implement subpixels of the display that are configured to emit a same color of light.

Clause 13. The method of clause 1, wherein: the first emitter implements a first subpixel configured to emit a first color of light; and the second emitter implements a second subpixel configured to emit a second color of light, the second color of light being different from the first color of light.

Clause 14. The method of clause 1, wherein: the display is integrated within a head-mounted display device configured to provide an extended reality experience to a user wearing the head-mounted display device; and each emitter of the array of emitters is implemented as a micro light emitting diode (microLED).

Clause 15. A display comprising: an array of emitters, the array of emitters including a first emitter having a deficiency; a memory configured to store frame data for a first frame and a second frame; and a display controller communicatively coupled to the memory and the array of emitters, the display controller configured to: display, on the array of emitters, the first frame including an instance of content, the instance of content including a point assigned to be displayed by the first emitter; identify, based on motion data indicating a movement of the instance of the content from the first frame to the second frame, a second emitter of the array of emitters that is assigned to display the point for the second frame; modify the frame data for the second frame to cause the second emitter to at least partially compensate for the deficiency of the first emitter; and display the second frame based on the frame data as modified.

Clause 16. The display of clause 15, wherein: the display is integrated within a head-mounted display device; the motion data is based on a head movement of a user of the head-mounted display device, the head movement having a rotational velocity; and the motion data is further based on a prediction that an eye movement of the user has a velocity equal and opposite to the rotational velocity of the head movement.

Clause 17. The display of clause 15, wherein: the display is integrated within a head-mounted display device; each emitter of the array of emitters is implemented as a micro light emitting diode (microLED); and the first emitter and the second emitter are microLEDs configured to emit a same color.

Clause 18. A non-transitory computer-readable medium storing instructions that, when executed by a display controller of a display having an array of emitters, cause the display to perform a method comprising: displaying, on the array of emitters, a first frame including an instance of content, the instance of content including a point assigned to be displayed by a first emitter of the array of emitters, the first emitter having a deficiency; identifying, based on motion data indicating a movement of the instance of the content from the first frame to a second frame, a second emitter of the array of emitters that is assigned to display the point for the second frame; modifying frame data for the second frame to cause the second emitter to at least partially compensate for the deficiency of the first emitter; and displaying the second frame based on the frame data as modified.

Clause 19. The non-transitory computer-readable medium of clause 18, wherein: the display is integrated within a head-mounted display device worn by a user within an environment; and the movement of the instance of the content from the first frame to the second frame is based on the instance of the content being world-locked content configured to appear stationary with respect to the environment as the user moves to change a field of view of the head-mounted display device.

Clause 20. The non-transitory computer-readable medium of clause 18, wherein: the instance of the content is an animated object; and the movement of the instance of the content from the first frame to the second frame is based on an animation of the animated object.

Various implementations of the systems and techniques described herein can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

A number of implementations have been described. It will be understood that various modifications may be made without departing from the spirit and scope of the description and claims. The described implementations are examples, and that other systems can be used to perform similar functions. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the implementations of the disclosure.

The terminology used herein is for the purpose of describing particular implementations only and is not intended to be limiting of the implementations. As used herein, the singular forms “a,” “an,” and “the” are intended to include the plural forms as well, unless the context clearly indicates otherwise. It will be further understood that the term “comprising,” when used in this specification, specifies the presence of the stated features, steps, operations, elements, and/or components, but does not preclude the presence or addition of one or more other features, steps, operations, elements, components, and/or groups thereof.

It will be understood that when an element is referred to as being “coupled” or “connected” to another element, it can be directly coupled or connected to the other element, or intervening elements may also be present. In contrast, when an element is referred to as being “directly coupled” or “directly connected” to another element, there are no intervening elements present.

Spatially relative terms, such as “beneath,” “below,” “lower,” “above,” “upper,” and the like, may be used herein for ease of description to describe one element or feature in relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (e.g., rotated 90 degrees or at other orientations) and the spatially relative descriptors used herein may be interpreted accordingly.

Further to the descriptions above, a user may be provided with controls allowing the user to make an election as to both if and when systems, programs, or features described herein may enable collection of user information (e.g., information about a user's preferences, or a user's current location), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized, such as to a city, zip code, or state level, so that a particular location of a user cannot be determined. Thus, the user may have control over what information is collected about the user, how that information is used, and what information is provided to the user.

While certain features of the described implementations have been illustrated as described herein, many modifications, substitutions, changes, and equivalents may occur to those skilled in the art. It is therefore to be understood that the appended claims are intended to cover such modifications and changes as fall within the scope of the implementations. It will be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components, and/or features of the different implementations described. As such, the scope of the present disclosure is not limited to the particular combinations hereafter claimed, but instead extends to encompass any combination of features or example implementations described herein irrespective of whether or not that particular combination has been specifically enumerated in the accompanying claims at this time.

What is claimed is:

1. A method comprising:
displaying, on a display having an array of emitters, a first frame including content having a point assigned to be displayed by a first emitter of the array of emitters;
identifying, based on motion data indicating a movement of the content from the first frame to a second frame, a second emitter of the array of emitters that is assigned to display the point for the second frame;
modifying frame data for the second frame to cause the second emitter to at least partially compensate for a deficiency of the first emitter; and
displaying the second frame based on the frame data as modified.

2. The method of claim 1, wherein:
the display is integrated within a head-mounted display device; and
the motion data is based on a head movement of a user of the head-mounted display device.

3. The method of claim 2, wherein:
the head movement has a rotational velocity; and
the motion data is based on a prediction that an eye movement of the user has a velocity equal and opposite to the rotational velocity of the head movement.

4. The method of claim 1, wherein the motion data is based on an analysis of how the frame data for the second frame is different from frame data for the first frame.

5. The method of claim 1, wherein:
the display includes an eye-tracking system configured to track an eye of a user of the display; and
the motion data is based on eye-tracking data received from the eye-tracking system.

6. The method of claim 1, further comprising determining, using an eye-tracking system configured to track an eye of a user of the display, that the point assigned to be displayed by the first emitter is within a foveal region of the eye of the user;
wherein the identifying of the second emitter and the modifying of the frame data for the second frame are performed in response to the determining that the point is within the foveal region.

7. The method of claim 1, wherein:
the second frame includes content having an additional point assigned to be displayed by the first emitter having the deficiency; and
the method further comprises:
identifying, based on additional motion data indicating a movement of the content from the second frame to a third frame, a third emitter of the array of emitters that is assigned to display the additional point for the third frame;
detecting, using an eye-tracking system configured to track an eye of a user of the display, a saccadic movement of the eye; and
based on the saccadic movement of the eye, displaying the third frame without modifying frame data for the third frame to cause the third emitter to at least partially compensate for the deficiency of the first emitter.

8. The method of claim 1, wherein the modifying of the frame data for the second frame includes modifying a value associated with the second emitter to cause a brightness of the second emitter to increase, for the second frame, by an amount corresponding to a degree of the deficiency of the first emitter.

9. The method of claim 1, wherein the modifying of the frame data for the second frame is performed at a stage when the frame data is fully rendered for display based on the content.

10. The method of claim 1, wherein:
the display is integrated within a head-mounted display device worn by a user within an environment; and
the movement of the content from the first frame to the second frame is based on the content being world-locked content configured to appear stationary with respect to the environment as the user moves to change a field of view of the head-mounted display device.

11. The method of claim 1, wherein:
the content includes an animated object that has the point; and
the movement of the content from the first frame to the second frame is based on an animation of the animated object.

12. The method of claim 1, wherein the first emitter and the second emitter both implement subpixels of the display that are configured to emit a same color of light.

13. The method of claim 1, wherein:
the first emitter implements a first subpixel configured to emit a first color of light; and
the second emitter implements a second subpixel configured to emit a second color of light, the second color of light being different from the first color of light.

14. The method of claim 1, wherein:
the display is integrated within a head-mounted display device configured to provide an extended reality experience to a user wearing the head-mounted display device; and
each emitter of the array of emitters is implemented as a micro light emitting diode (microLED).

15. A display comprising:
an array of emitters;
a memory configured to store frame data for a first frame and a second frame; and
a display controller communicatively coupled to the memory and the array of emitters, the display controller configured to:
display, on the array of emitters, the first frame including content having a point assigned to be displayed by a first emitter of the array of emitters;
identify, based on motion data indicating a movement of the content from the first frame to the second frame, a second emitter of the array of emitters that is assigned to display the point for the second frame;
modify the frame data for the second frame to cause the second emitter to at least partially compensate for a deficiency of the first emitter; and
display the second frame based on the frame data as modified.

16. The display of claim 15, wherein:
the display is integrated within a head-mounted display device;
the motion data is based on a head movement of a user of the head-mounted display device, the head movement having a rotational velocity; and
the motion data is further based on a prediction that an eye movement of the user has a velocity equal and opposite to the rotational velocity of the head movement.

17. The display of claim 15, wherein:
the display is integrated within a head-mounted display device;
each emitter of the array of emitters is implemented as a micro light emitting diode (microLED); and
the first emitter and the second emitter are microLEDs configured to emit a same color.

18. A non-transitory computer-readable medium storing instructions that, when executed by a display controller of a display having an array of emitters, cause the display to perform a method comprising:
displaying, on the array of emitters, a first frame including content having a point assigned to be displayed by a first emitter of the array of emitters;
identifying, based on motion data indicating a movement of the content from the first frame to a second frame, a second emitter of the array of emitters that is assigned to display the point for the second frame;
modifying frame data for the second frame to cause the second emitter to at least partially compensate for a deficiency of the first emitter; and
displaying the second frame based on the frame data as modified.

19. The non-transitory computer-readable medium of claim 18, wherein:
the display is integrated within a head-mounted display device worn by a user within an environment; and
the movement of the content from the first frame to the second frame is based on the content being world-locked content configured to appear stationary with respect to the environment as the user moves to change a field of view of the head-mounted display device.

20. The non-transitory computer-readable medium of claim 18, wherein:
the content includes an animated object that has the point; and
the movement of t the content from the first frame to the second frame is based on an animation of the animated object.
